(19) United States
(12) Patent Application Publication
(10) Pub. No.: US 2025/0371476 A1
(43) Pub. Date: Dec. 4, 2025

(54) CYBER RISK MINIMIZATION THROUGH ASSESSMENT OF RETURN ON INVESTMENT BASED ON COST OF CAPITAL TO COVER LOSSES RESULTING FROM CATASTROPHIC EVENTS

(71) Applicant: Monaco Risk Analytics Inc., Saratoga, CA (US)

(72) Inventors: James S. Lipkis, Saratoga, CA (US); William R. Frank, Westborough, MA (US)

(21) Appl. No.: 19/222,932

(22) Filed: May 29, 2025

Related U.S. Application Data
(60) Provisional application No. 63/653,705, filed on May 30, 2024.

(51) Int. Cl. G06Q 10/0637; G06Q 10/0635

(52) U.S. Cl. CPC G06Q 10/06375; G06Q 10/0635

(57) ABSTRACT

A method includes calculating, for each proposed set of controls in a plurality of proposed sets of controls for protecting against a specified loss event, a loss basis incurred by an organization due to the specified loss event, assuming the each set of controls is implemented, calculating, for the each proposed set of controls and using the loss basis as a proxy for an effective annualized cost of capital to cover the specified loss event, a return on investment in the each proposed set of controls, delivering to a remote user endpoint device, data summarizing the return on investment for at least a subset of the plurality of proposed sets of controls, receiving a signal from the remote user endpoint device indicating a selection of a selected set of controls from the subset, and modifying a baseline set of controls to implement the selected set of controls.

### CROSS REFERENCE TO RELATED APPLICATIONS

This application claims the benefit of United Stated Provisional Patent Application Ser. No. 63/653,705, filed May 30, 2024, which is herein incorporated by reference in its entirety.

### FIELD OF THE DISCLOSURE

The present disclosure relates generally to cyber security, and relates more particularly to devices, non-transitory computer-readable media, and methods for minimizing cyber risk through assessment of return on investment based on cost of capital to cover losses resulting from catastrophic events.

### BACKGROUND OF THE DISCLOSURE

Cybersecurity has emerged as a paramount risk to organizations both public and private in the twenty first century. This is due not only to expensive and disruptive incidents such as ransomware attacks and compromise of sensitive business information, but also to the growing complexity of modern information technology, which leads to frequent errors and accidents that result in security exposures. Government and industry regulators have increased rulemaking and enforcement, while shareholders and other stakeholders exert pressure in the form of litigation. Liability and compliance risks add to the urgency and complexity of rigorous governance of cybersecurity posture at all levels of an organization.

Risk managers have come to understand that cyberattacks cannot be entirely prevented, and therefore cyber risk cannot be completely eliminated. Cyber risk can, however, be managed and mitigated through a variety of countermeasures known as controls. Controls include technical components and tools (e.g., firewalls, anti-malware agents, identity and access management, encryption, etc.), architectural aspects (e.g., cloud deployment or application platform characteristics), administrative processes and policies (e.g., secure employee onboarding/offboarding, configuration change management, incident response playbooks, periodic incident response exercises, etc.), and employee training (e.g., security awareness, anti-phishing testing, etc.). Most controls are attack-surface controls which directly counter vulnerabilities or attack vectors exploited by cyber adversaries.

### SUMMARY

In one example, the present disclosure describes a device, computer-readable medium, and method for cyber risk minimization. For instance, in one example, a method includes calculating, for each proposed set of controls in a plurality of proposed sets of controls for protecting against a specified loss event, a loss basis incurred by an organization due to the specified loss event, assuming the each set of controls is implemented, calculating, for the each proposed set of controls and using the loss basis as a proxy for an effective annualized cost of capital to cover the specified loss event, a return on investment in the each proposed set of controls, delivering to a remote user endpoint device, data summarizing the return on investment for at least a subset of the plurality of proposed sets of controls, receiving a signal from the remote user endpoint device indicating a selection of a selected set of controls from the subset, and modifying a baseline set of controls to implement the selected set of controls.

In another example, a device includes a processing system including at least one processor and a computer-readable medium storing instructions which, when executed by the processing system, cause the processing system to perform operations. The operations include calculating, for each proposed set of controls in a plurality of proposed sets of controls for protecting against a specified loss event, a loss basis incurred by an organization due to the specified loss event, assuming the each set of controls is implemented, calculating, for the each proposed set of controls and using the loss basis as a proxy for an effective annualized cost of capital to cover the specified loss event, a return on investment in the each proposed set of controls, delivering to a remote user endpoint device, data summarizing the return on investment for at least a subset of the plurality of proposed sets of controls, receiving a signal from the remote user endpoint device indicating a selection of a selected set of controls from the subset, and modifying a baseline set of controls to implement the selected set of controls.

In another example, a non-transitory computer-readable medium stores instructions which, when executed by a processing system including at least one processor, cause the processing system to perform operations. The operations include calculating, for each proposed set of controls in a plurality of proposed sets of controls for protecting against a specified loss event, a loss basis incurred by an organization due to the specified loss event, assuming the each set of controls is implemented, calculating, for the each proposed set of controls and using the loss basis as a proxy for an effective annualized cost of capital to cover the specified loss event, a return on investment in the each proposed set of controls, delivering to a remote user endpoint device, data summarizing the return on investment for at least a subset of the plurality of proposed sets of controls, receiving a signal from the remote user endpoint device indicating a selection of a selected set of controls from the subset, and modifying a baseline set of controls to implement the selected set of controls.

### BRIEF DESCRIPTION OF THE DRAWINGS

The teachings of the present disclosure can be readily understood by considering the following detailed description in conjunction with the accompanying drawings, in which:

FIG. 1 illustrates an example of a loss distribution corresponding to a hypothetical ransomware event that disrupts a revenue business process;

FIG. 2 illustrates an example system in which examples of the present disclosure for minimizing cyber risk through an assessment of return on investment based on cost of capital to cover losses resulting from catastrophic events may operate;

FIG. 3 illustrates a flowchart of a first example method for minimizing cyber risk through an assessment of return on investment based on cost of capital to cover losses resulting from catastrophic events, according to examples of the present disclosure;

FIG. 4 illustrates an example graphical user interface that may be used to present a list of predefined proposed sets of controls;

FIG. 5 illustrates an example graphical user interface that may be used to summarize the returns on investments for a plurality of proposed sets of controls; and

FIG. 6 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure minimizes cyber risk through an assessment of return on investment based on cost of capital to cover losses resulting from catastrophic events. As discussed above, cybersecurity has emerged as a paramount risk to organizations both public and private in the twenty first century. However, due to the highly technical nature of cybersecurity, along with the challenges of responding to hazards that turn on human psychological motivations and factors among both perpetrators and defenders, cybersecurity has not traditionally been managed as a business risk (e.g., in tandem with other enterprise risks and opportunities according to an organization's priorities). Executive and financial managers do not speak the technical language of cyber elements and metrics, and cybersecurity managers have not had the necessary tools for communicating cybersecurity-related priorities and tradeoffs in business terms.

Cyber risk is typically managed and mitigated through a variety of countermeasures, also referred to as controls. Controls include a wide variety of tools involving people, processes, and technology designed to reduce the frequency of occurrence and the financial impact of cybersecurity events. For instance, controls may include technical components and tools (e.g., firewalls, anti-malware agents, identity and access management, encryption, etc.), architectural aspects (e.g., cloud deployment or application platform characteristics), administrative processes and policies (e.g., secure employee onboarding/offboarding, configuration change management, incident response playbooks, periodic incident response exercises, etc.), and employee training (e.g., security awareness, anti-phishing testing, etc.). The landscape of controls is vast, complex, and highly volatile due to rapidly evolving technology and shifts in attack surface and growing attacker sophistication.

Due to the complexity, churn, and lack of meaningful metrics, many organizations select and implement controls primarily by instinct. Often, organizations may underspend on controls because the risk is invisible, and expenditures offer no tangible or easily visible return on investment. Cybersecurity is often seen purely as a cost center rather than a business enabler.

Investment alternatives in the course of managing an organization are often assessed using cost-benefit analysis. Forecast return on investment, calculated by risk or other financial models, is generally a useful gauge of efficiency, and, hence, utility of any expenditure or resource allocation. In operational risk management, return on investment analysis works well for hazards that occur on a regular, predictable basis. For instance, small loss events, like employee theft or shoplifting in retail companies, occur multiple times per year. Risk managers will typically monitor the annual total of such losses over time. When the annual total exceeds a defined threshold, incremental investments in controls may be mandated to reduce the loss and mitigate the risk.

The “benefit” side of cost-benefit analysis for operational hazard risk is loss reduction. In the above example, the loss reduction is tangible and concrete (e.g., reduced number of employee theft or shoplifting events). Both incremental control costs and theft losses are incurred and can be tracked on an annual basis. It is possible to estimate return on investment by subtracting the incremental control costs from the expected loss reduction, and dividing by the costs of the controls.

Severe cyber risks, however, must be assessed with respect to longer time epochs, similar to natural disasters such as catastrophic earthquakes. A severe incident of, for instance, ransomware or compromise of sensitive data may be forecast to impact a specific organization only once every fifty or one hundred years (or even less frequently). Because of the large number of such organizations, these incidents tend to occur very often on a national or global scale, but rarely occur more than once to the same organization. Often, the expected frequency of incidents is inversely correlated with severity (i.e., the expected loss resulting from such an event increases as the frequency with which the event is expected to occur decreases); thus catastrophic loss events are very rare, and may sometimes be referred to as “tail events.”

Calculation of return on investment for tail events is less straightforward than calculation of return on investment for events that are predicted to occur on a more frequent or regular basis per year. Risk or loss reduction means a reduction in the frequency and/or severity of these rare events; however, while incremental control costs are incurrent on an annual basis, the benefits of the controls are realized on a far longer time scale. The challenge of return on investment analysis in this case is to compare an annual control expenditure against, say, a one hundred-year benefit. In other words, it is difficult to annualize the value of the return or benefit of these incremental controls.

A means of annualizing takes the average annual loss (AAL) and computes return on investment using the forecast reduction in AAL due to a proposed set of control investments. AAL is easy to explain to an organization's stakeholders. However, AAL has severe disadvantages that render AAL inadvisable for use in business investment decisions and ineffective as a means of assuring security against cyber risks. For instance, the AAL dollar number for a rare loss event is a proxy for the loss (i.e., AAL does not reflect a real loss amount). AAL does not appear on an organization's financial statements, such as a profit and loss (P&L) statement. Moreover, AAL is not even a useful proxy for a rare but severe loss event, since AAL fails to capture the potential magnitude of the loss (and, hence, fails to capture the magnitude of the impact of the loss to the organization). AAL thus minimizes, and even trivializes, the risk. This is because the amount of the loss is, roughly speaking, divided by the expected period between severe loss events, which yields a deceptively small number.

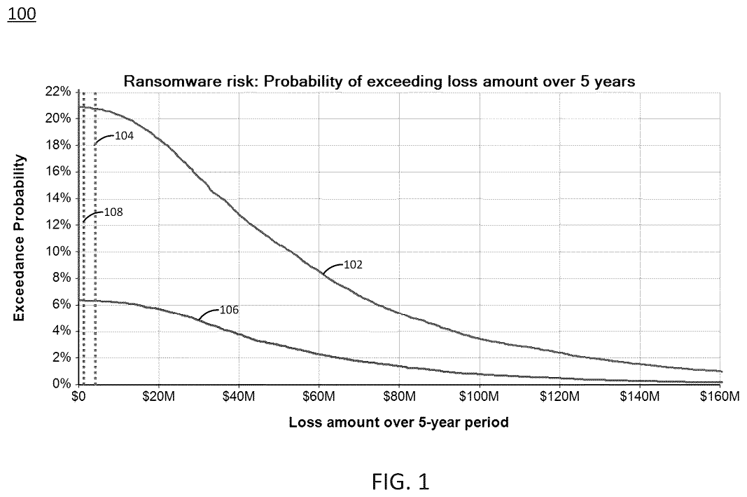

FIG. 1 illustrates an example of a loss distribution 100 corresponding to a hypothetical ransomware event that disrupts a revenue business process. The upper curve 102 of FIG. 1 illustrates an example organization's current risk of business disruption due to a ransomware attack. In this case, risk is illustrated as a loss exceedance curve (LEC), which reflects the probability of exceeding a given loss amount over a five-year period. As illustrated, a loss in the high tens or low hundreds of millions of dollars is, though rare, realistically probable.

However, the single-year AAL 104, which in FIG. 1 is represented by the mean of the loss distribution 100, is less than three million dollars. This deceptively small amount may distract attention from the actual expected loss and frustrate efforts to appropriately defend against the risk. Similar, a return on investment analysis based on AAL will minimize the apparent cost-benefit value of any proposed defensive measures.

The lower curve 106 of FIG. 1 illustrates the example organization's current risk of business disruption due to a ransomware attack when a set of increased security measures is implemented. In this case, the expected loss amounts are substantially smaller. However, again, AAL 108 reduces the loss to a trivial amount. Loss reduction due to countermeasures appears to be less than two million dollars on an annualized basis, although in reality the loss reduction due to countermeasures could range from fifty million to seventy million dollars or more over a five-year period during which the ransomware attack occurs.

Thus, current approaches due not credibly annualize the business impact of a risk for which actual occurrence is very low, but the resulting losses are significant. Annualizing by averaging, or spreading the significant losses evenly over long intervals of time, masks the true value of the potential loss and fails to account for the cost of the controls when the loss event occurs.

Examples of the present disclosure provide a means to minimize cyber risk, given a defined budget for countermeasures or controls. In one example, a cost-benefit analysis based on return on investment (as calculated by quantitative risk models) is used to select a strategy from among multiple candidate strategies designed to reduce the frequency and impact of cyber risk events. The return on investment analysis is based on the reduction in loss basis (i.e., the annualized cost of capital required to cover losses incurred due to a potential loss event, rather than an average annualized loss due to the potential loss event.

In this case, the cost of capital to cover a catastrophic loss may be viewed as follows. When a catastrophic loss event occurs (due to, for instance, a sever ransomware attack or a liability related to a data breach), the loss must be covered by some means outside of normal business operations. Typically, there are options for covering this loss: (1) maintaining cash reserves to cover the loss (which incurs an annual interest expense); or (2) obtaining the required funds to cover the loss from credit markets after the loss occurs. Because severe loss events are expected to occur rarely, examples of the present disclosure model the interest expense corresponding to the latter option as a continuous steady-state cost.

Examples of the present disclosure define a loss basis as the effective annualized cost of capital to cover an identified type of hazard (or loss event), given a baseline or status quo set of controls. The benefit from a proposed set of controls is realized as a reduction in the loss basis, and that reduction, in turn, represents a return on investment for the proposed set of controls. This allows for meaningful comparison of multiple different proposed sets of controls to identify and implement an optimal set of controls that balances the loss incurred due to a rare but catastrophic event against the costs of minimizing that loss.

The loss basis is a probability distribution, typically forecast by a quantitative risk model that takes into account both the likelihood (or annual frequency) and the resulting financial impact of a hazard. The probability distribution reflects the inherent uncertainty in forecasting future financial losses based on risk factor inputs. The probability distribution may take either a symmetric or a skewed shape. A symmetric loss distribution results from a routine hazard (e.g., typically multiple incidents occurring within a single year or other short time horizon). The mean of the probability distribution in this case (or average annual periodic loss) is a forecast of actual expected loss during the period and serves as a loss basis for return on investment purposes. A skewed loss distribution results from a hazard for which severity increases with rarity (e.g., infrequent catastrophic losses). The mean of the probability distribution in this case is not a useful loss basis for return on investment purposes, as discussed above. Because the magnitude of a rare severe loss can be extremely and arbitrarily high (as expected frequency declines), the magnitude of the loss cannot be reliably used as an annual loss basis. Examples of the present disclosure thus use the annual cost of capital to cover the forecast loss as a realistic proxy for the annualized business impact of a hazard in question. In some cases, the capital required to cover losses caused by a catastrophic event may be into the hundreds of millions or even billions of dollars.

It should be noted that although examples of the present disclosure are discussed within the example context of cyber security, the examples may be more broadly applicable to minimizing other types of hazard risk. This and other aspects of the present disclosure are discussed in greater detail below with reference to FIGS. 1-6.

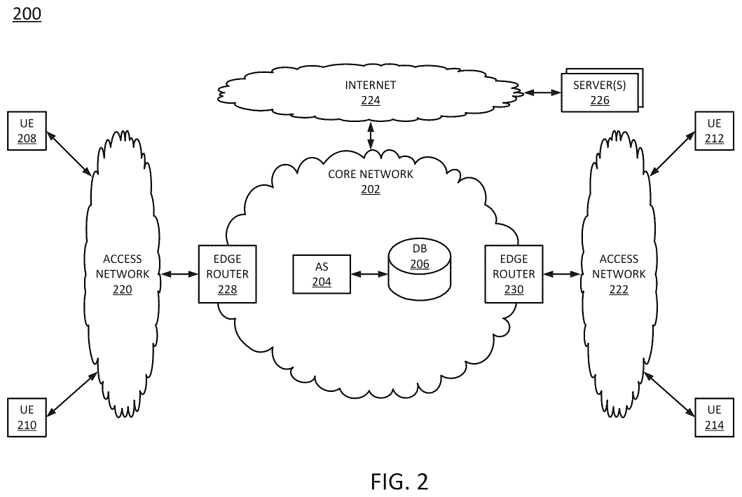

To further aid in understanding the present disclosure, FIG. 2 illustrates an example system 200 in which examples of the present disclosure for minimizing cyber risk through an assessment of return on investment based on cost of capital to cover losses resulting from catastrophic events may operate. The system 200 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SolP) networks, the World Wide Web, and the like.

In one example, the system 200 may comprise a core network 202. The core network 202 may be in communication with one or more access networks 220 and 222, and with the Internet 224. In one example, the core network 202 may functionally comprise a fixed mobile convergence (FMC) network, e.g., an IP Multimedia Subsystem (IMS) network. In addition, the core network 202 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. In one example, the core network 202 may include at least one application server (AS) 104, at least one database (DB) 206, and a plurality of edge routers 228-230. For ease of illustration, various additional elements of the core network 202 are omitted from FIG. 2.

In one example, the access networks 220 and 222 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 202 may provide a telecommunication service to subscribers via access networks 220 and 222. In one example, the access networks 220 and 222 may comprise different types of access networks, may comprise the same type of access network, or some access networks may be the same type of access network and others may be different types of access networks. In one example, the core network 202 may be operated by a telecommunication network service provider. The core network 202 and the access networks 220 and 222 may be operated by different service providers, the same service provider or a combination thereof, or the access networks 220 and/or 222 may be operated by entities having core businesses that are not related to telecommunications services, e.g., corporate, governmental, or educational institution LANs, and the like.

In one example, the access network 220 may be in communication with one or more user endpoint devices 208 and 210. Similarly, the access network 222 may be in communication with one or more user endpoint devices 212 and 214. The access networks 220 and 222 may transmit and receive communications between the user endpoint devices 208, 210, 212, and 214, between the user endpoint devices 208, 210, 212, and 214, the server(s) 226, the AS 204, other components of the core network 202, devices reachable via the Internet in general, and so forth. In one example, each of the user endpoint devices 208, 210, 212, and 214 may comprise any single device or combination of devices that may comprise a user endpoint device. For example, the user endpoint devices 208, 210, 212, and 214 may each comprise a mobile device, a cellular smart phone, a laptop computer, a tablet computer, a desktop computer, an application server, a bank or cluster of such devices, and the like.

In one example, one or more servers 226 may be accessible to user endpoint devices 208, 210, 212, and 214 via Internet 224 in general. The server(s) 226 may operate in a manner similar to the AS 204, which is described in further detail below.

In accordance with the present disclosure, the AS 204 and DB 206 may be configured to provide one or more operations or functions in connection with examples of the present disclosure for minimizing cyber risk, as described herein. For instance, the AS 204 may be configured to operate as a Web portal or interface via which a user endpoint device, such as any of the UEs 208, 210, 212, and/or 214, may access an application that assesses, designs, and/or implements enhancements to strengthen an organization's cyber posture and reduce the organization's level of cyber risk.

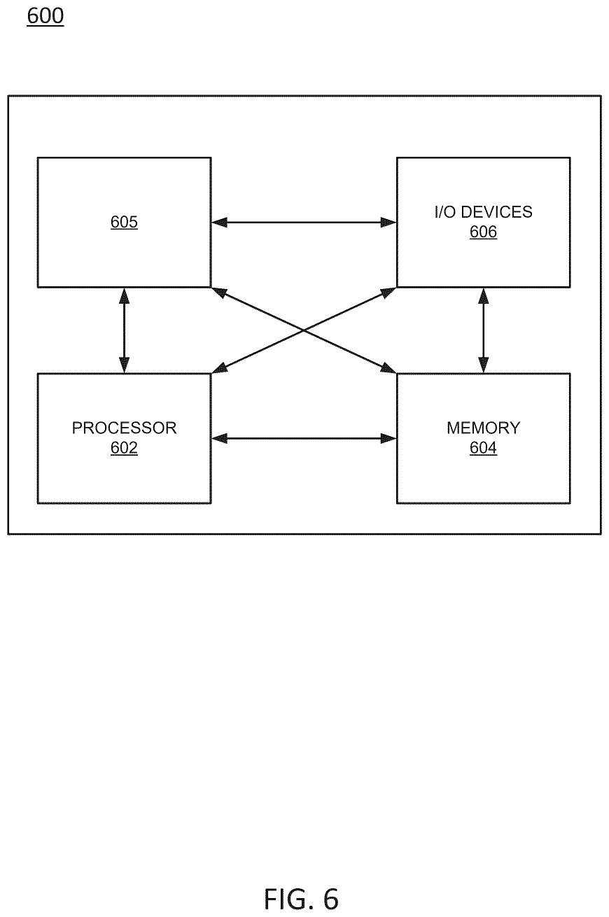

To this end, the AS 204 may comprise one or more physical devices, e.g., one or more computing systems or servers, such as computing system 600 depicted in FIG. 6, and may be configured as described above. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

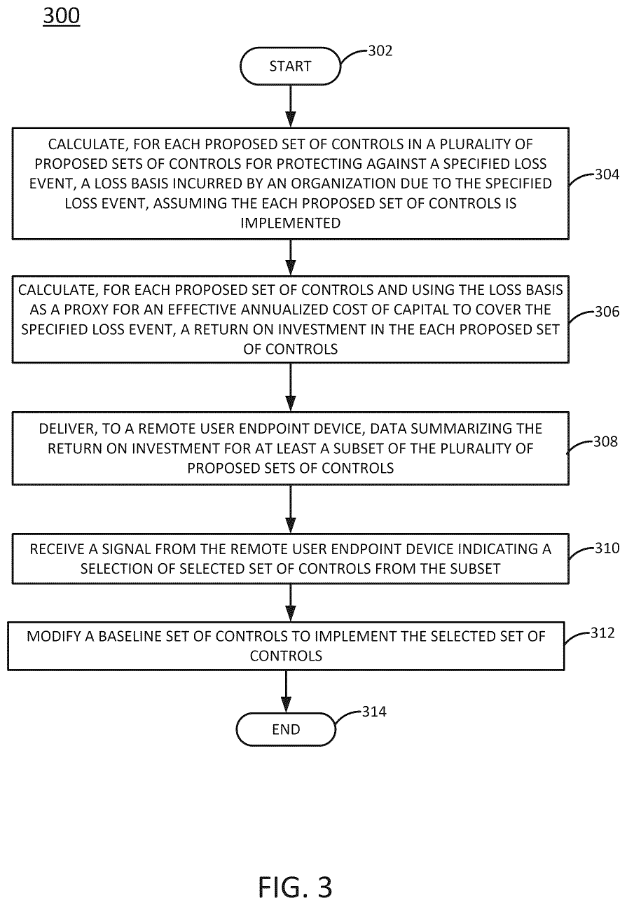

For instance, in one example, the AS 204 may perform a series of operations related to assessing, designing, and implementing enhancements to strengthen an organization's cyber posture and reduce the organization's level of cyber risk. In one example, the operations include one or more of the following steps: (1) calculate, for each proposed set of controls in a plurality of proposed sets of controls for protecting against a specified loss event, a loss basis incurred by an organization due to the specified loss event, assuming the each set of controls is implemented; (2) calculate, for the each proposed set of controls and using the loss basis as a proxy for an effective annualized cost of capital to cover the specified loss event, a return on investment in the each proposed set of controls; (3) deliver, to a remote user endpoint device, data summarizing the return on investment for at least a subset of the plurality of proposed sets of controls; (4) receive a signal from the remote user endpoint device indicating a selection of a selected set of controls from the subset; and (5) modify a baseline set of controls to implement the selected set of controls. These operations are discussed in further detail below in connection with FIG. 3.

The AS 204 may have access to at least one database (DB) 206, where the DB 206 may store information related to the controls currently implemented by an organization, vendors (if any) associated with the controls, past simulations and analyses of the controls, various proposals related to enhancements of the controls, previous successfully and/or attempted attacks, and/or other information.

It should be noted that the system 200 has been simplified. Thus, those skilled in the art will realize that the system 200 may be implemented in a different form than that which is illustrated in FIG. 2, or may be expanded by including additional endpoint devices, access networks, network elements, application servers, etc. without altering the scope of the present disclosure. In addition, system 200 may be altered to omit various elements, substitute elements for devices that perform the same or similar functions, combine elements that are illustrated as separate devices, and/or implement network elements as functions that are spread across several devices that operate collectively as the respective network elements. For example, the system 200 may include other network elements (not shown) such as border elements, routers, switches, policy servers, security devices, gateways, a content distribution network (CDN) and the like. For example, portions of the core network 202, access networks 220 and 222, and/or Internet 224 may comprise a content distribution network (CDN) having ingest servers, edge servers, and the like. Similarly, although only two access networks, 220 and 222 are shown, in other examples, access networks 220 and/or 222 may each comprise a plurality of different access networks that may interface with the core network 202 independently or in a chained manner. For example, UE devices 208, 210, 212, and 214 may communicate with the core network 202 via different access networks, user endpoint devices 210 and 212 may communicate with the core network 202 via different access networks, and so forth. Thus, these and other modifications are all contemplated within the scope of the present disclosure.

FIG. 3 illustrates a flowchart of a first example method 300 for minimizing cyber risk through an assessment of return on investment based on cost of capital to cover losses resulting from catastrophic events, according to examples of the present disclosure. In one example, the method 300 may be performed by an application server, e.g., AS 204 of FIG. 2, alone or in combination with other devices. In another example, the method 300 may be performed by a computing device or a processor of a computing device, such as the computing device 600 discussed below in conjunction with FIG. 6. For the sake of example, the method 300 is described as being performed by a processing system.

The method 300 begins in step 302. In step 304, the processing system may calculate, for each proposed set of controls in a plurality of proposed sets of controls for protecting against a specified loss event, a loss basis incurred by an organization due to the specified loss event, assuming the each set of controls is implemented.

In one example, the specified loss event may be a rare, catastrophic, cyber-security-based loss event. In other words, the loss event may be a loss event whose likelihood of occurring in any single given year may be low, but whose financial impact is significantly higher than the smaller loss events that occur more frequently throughout any given year. For instance, the specified loss event may comprise a ransomware attack, a data breach, or the like, as opposed to employee theft or shoplifting. Thus, in this context, the loss basis may be defined as the perpetual risk of loss from the specified event that the organization maintains on its “books” in an implicit and invisible manner.

In one example, each proposed set of controls may include any combination of technical components and tools (e.g., firewalls, anti-malware agents, identity and access management, encryption, etc.), architectural aspects (e.g., cloud deployment or application platform characteristics), administrative processes and policies (e.g., secure employee onboarding/offboarding, configuration change management, incident response playbooks, periodic incident response exercises, etc.), and employee training (e.g., security awareness, anti-phishing testing, etc.). Any proposed set of controls is designed to reduce the loss basis (or risk), but will impose a financial cost to implement. Different proposed sets of controls in the plurality of proposed sets of controls may include different combinations of technical components and tools, architectural aspects, administrative processes and policies, and employee training. In one example, the plurality of proposed sets of controls may include a baseline set of controls that represents the status quo (i.e., a currently implemented set of controls) against which the other proposed sets of controls may be compared.

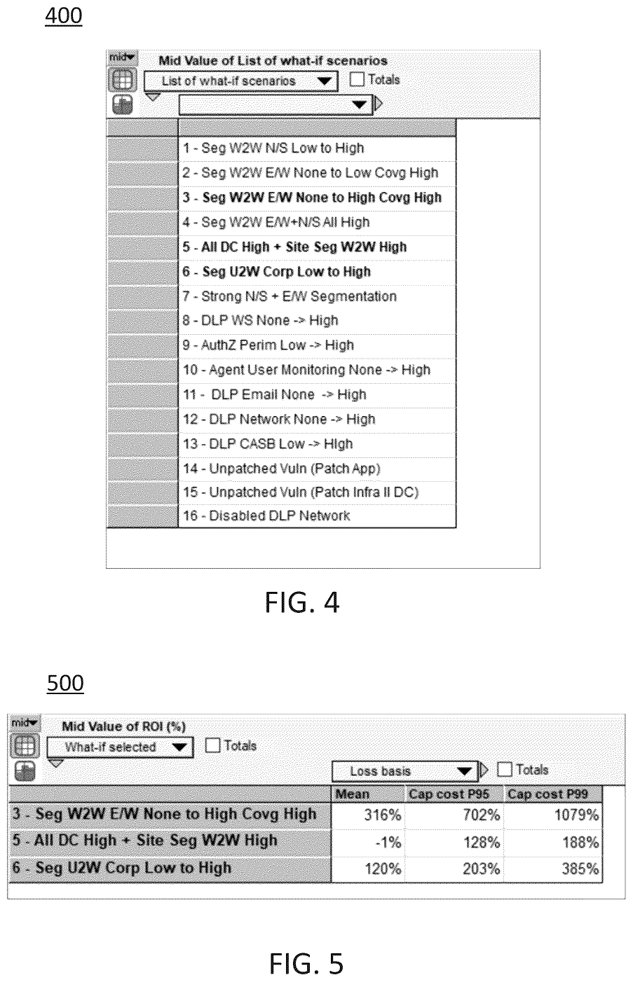

In one example, the plurality of proposed sets of controls may be selected from a list of predefined proposed sets of controls. For instance, the processing system may push, to a graphical user interface (GUI) of a remote user endpoint device, a drop down list, a table, or another GUI element that presents the list of predefined proposed sets of controls. FIG. 4, for example, illustrates an example graphical user interface 400 that may be used to present a list of predefined proposed sets of controls. In the example of FIG. 4, each predefined proposed set of controls is identified by a number (e.g., 1 through 16). A user of the user endpoint device may then use the GUI 400 to select the plurality of proposed sets of controls from the list (e.g., by clicking on any of the predefined proposed sets of controls 1-16 the user wants to evaluate). In another example, the user of the user endpoint device may define one or more proposed sets of controls of the plurality of proposed sets of controls (e.g., one or more of the proposed sets of controls may not be predefined).

In one example, the loss basis is calculated based on: (1) a forecast baseline loss distribution from a quantitative model of the risk, taking into account all risk factors that determine the likelihood and the impact of loss event; (hereinafter referred to as “LossDistBaseline”) (2) a forecast reduced loss distribution from a quantitative model of the risk, taking into account all risk factors that determine the likelihood and the impact of loss event, taking into account a proposed set of controls to reduce the risk (hereinafter referred to as “LossDistReduced”); (3) a selected percentile level (e.g., ranging from ninety to ninety-nine percent) designating a point on the loss distribution to be used as the hypothetical total loss in the calculation of annual cost of capital (hereinafter referred to as “SelectedPercentile”); (4) a time period (e.g., sequence of years) over which return on investment is to be calculated (hereinafter referred to as “Period”); (5) the cost of the proposed set of controls in the first year of deployment (hereinafter referred to as “InitYearCost”); (6) the cost of the proposed set of controls in each subsequent year of Period after the first year (hereinafter referred to as “LaterYearCost”); (7) the inflation rate for the annual expense (including vendor expenses and internal expenses) of the proposed set of controls (hereinafter referred to as “ControlInflationRate”); (8) the discount rate for net present value (NPV) calculation (hereinafter referred to as “DiscountRate”); and (9) the interest rate for long-term capital, corresponding to a combination of capital reserve carrying cost and credit market interest rate for a potentially unsecured loan (hereinafter referred to as “CapitalIntRate”).

In step 306, the processing system may calculate, for the each proposed set of controls and using the loss basis as a proxy for an effective annualized cost of capital to cover the specified loss event, a return on investment in the each proposed set of controls.

In one example, the return on investment (ROI) may be calculated as:

$$ROI = ( ( LossBasisBaseline - LossBasisReduced ) - TotalControlCost ) \text{} / TotalControlCost - 1 \\ where \qquad ( EQN . 1 )$$

$$LossAmountBaseline = Fractile ( LossDistBaseline , SelectedPerentile ) \qquad ( EQN . 2 )$$

$$LossAmountReduced = Fractile ( LossDistReduced , SelectedPerentile ) \qquad ( EQN . 3 )$$

$$LossBasisBaseline = NetPresentValue ( DiscountRate , LossAmountBaseline \times CapitallntRate , Period ) \qquad ( EQN . 4 )$$

$$LossBasisReduced = NetPresentValue ( DiscountRate , LossAmountReduced \times CapitallntRate , Period ) \qquad ( EQN . 5 )$$

$$TotalControlCost = NetPresentValue ( DiscountRate - ControllnflationRate , ControlCostOutflow , Period ) \qquad ( EQN . 6 )$$

and where NetPresentValue and Fractile are standard mathematical functions. Thus, ROI is calculated in step 306 as the cost-of-capital-based return on investment for subsequent comparison and decision support purposes.

Thus, to summarize and simplify, the return on investment for each proposed set of controls may be calculated, over a defined period, as the reduction in loss basis (relative to the status quo or baseline) that is expected over the defined period if a proposed set of controls is implemented minus the financial cost to implement the proposed set of controls, divided by the financial cost to implement the proposed set of controls.

In step 308, the processing system may deliver, to a remote user endpoint device, data summarizing the return on investment for at least a subset of the plurality of proposed sets of controls.

For instance, in one example the processing system may present the data summarizing the return on investment via a GUI. FIG. 5 illustrates an example graphical user interface 500 that may be used to summarize the returns on investments for a plurality of proposed sets of controls. In the example of FIG. 5, the proposed sets of controls correspond to the proposed sets of controls numbered 3, 5, and 6 in FIG. 4. In the example of FIG. 5, the GUI 500 presents the mean (e.g., five-year annualized average) ROI, as well as the cost of capital to cover a 95^{th} percentile loss (e.g., corresponding to a five percent chance of a loss amount being exceeded), and the cost of capital to cover a 99^{th} percentile loss (e.g., corresponding to a one percent chance of a loss amount being exceeded). However, different percentiles may be selected (e.g., by the user) for cost of capital calculations.

In step 310, the processing system may receive a signal from the remote user endpoint device indicating a selection of a selected set of controls from the subset.

For instance, as discussed above, the GUI 500 may be displayed on the remote user endpoint device. A user of the remote user endpoint device may click on one of the proposed sets of controls displayed in the GUI 500, such as a proposed set of controls that is preferred by the user based on the presented data. Clicking on the selected set of controls may cause a machine readable signal to be sent to the processing system that causes the processing system to take an action. In one example, that action is taken in step 312.

In step 312, the processing system may modify a baseline set of controls to implement the selected set of controls.

For instance, the baseline set of controls may be the set of controls that is currently implemented by the organization in the organization's information technology (IT) infrastructure to guard against the loss event. However, the selected set of controls may be different from the baseline set of controls. Thus, the processing system may need to take one or more actions, for instance by modifying a setting of one or more existing controls in the baseline set of controls, to implement the selected set of controls. The processing system may send a machine readable signal to one or more machines responsible for controlling the settings of the existing controls that causes the one or more machines to take an action to implement the selected set of controls.

In one example, modifying the baseline set of controls may comprise sending an instruction that causes a machine to change a setting of a technical component or tool, such as a firewall, an anti-malware agent, an identity and access management system, an encryption setting, or the like. In one example, changing a setting of a technical component or tool may include activating a new technical component or tool, or disabling an existing technical component or tool. In another example, changing a setting of a technical component or tool may include simply modifying the way in which an existing technical component or tool operates (e.g., increasing the sensitivity of a firewall, implementing a stronger encryption algorithm, etc.).

In another example, modifying the baseline set of controls may comprise sending an instruction that causes a machine to change an architectural aspect of the organization's IT infrastructure. For instance, changing an architectural aspect of the IT infrastructure may include deploying one or more computing systems or applications utilized by the organization in the cloud or changing the application platform characteristics of an application utilized by the organization.

In another example, modifying the baseline set of controls may comprise sending an instruction that causes a machine to update or revise an administrative process or policy of the organization, such as a process or policy relating to secure employee onboarding/offboarding, configuration change management, incident response playbooks, periodic incident response exercises, or the like.

In another example, modifying the baseline set of controls may comprise sending an instruction that causes a machine to update or revise employee training materials, such as training materials relating to security awareness, anti-phishing testing, or the like.

In step 314, the method 300 may end.

Although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 6 depicts a high-level block diagram of a computing device specifically programmed to perform the functions described herein. For example, any one or more components or devices illustrated in FIG. 2 or described in connection with the method 300 may be implemented as the system 600. For instance, a user endpoint device or an application server (such as might be used to perform the method 300) could be implemented as illustrated in FIG. 6.

As depicted in FIG. 6, the system 600 comprises a hardware processor element 602, a memory 604, a module 605 for cyber risk minimization, and various input/output (I/O) devices 606.

The hardware processor 602 may comprise, for example, a microprocessor, a central processing unit (CPU), or the like. The memory 604 may comprise, for example, random access memory (RAM), read only memory (ROM), a disk drive, an optical drive, a magnetic drive, and/or a Universal Serial Bus (USB) drive. The module 605 for cyber risk minimization may include circuitry and/or logic for performing special purpose functions relating to assessing and minimizing cyber risk. The input/output devices 606 may include, for example, a camera, a video camera, storage devices (including but not limited to, a tape drive, a floppy drive, a hard disk drive or a compact disk drive), a receiver, a transmitter, a speaker, a microphone, a transducer, a display, an output port, or a user input device (such as a keyboard, a keypad, a mouse, and the like).

Although only one processor element is shown, it should be noted that the general-purpose computer may employ a plurality of processor elements.

Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 605 for cyber risk minimization (e.g., a software program comprising computer-executable instructions) can be loaded into memory 604 and executed by hardware processor element 602 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for cyber risk minimization (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method, comprising:
calculating, by a processing system including at least one processor, and for each proposed set of controls in a plurality of proposed sets of controls for protecting against a specified loss event, a loss basis incurred by an organization due to the specified loss event, assuming the each set of controls is implemented;
calculating, by the processing system and for the each proposed set of controls and using the loss basis as a proxy for an effective annualized cost of capital to cover the specified loss event, a return on investment in the each proposed set of controls;
delivering, by the processing system, to a remote user endpoint device, data summarizing the return on investment for at least a subset of the plurality of proposed sets of controls;
receiving, by the processing system, a signal from the remote user endpoint device indicating a selection of a selected set of controls from the subset; and
modifying, by the processing system, a baseline set of controls to implement the selected set of controls.

2. The method of claim 1, wherein the specified loss event is a cyber-security-based loss event.

3. The method of claim 2, wherein the cyber-security-based loss event is at least one of: a ransomware attack or a data breach.

4. The method of claim 1, wherein the loss basis represents a perpetual risk of loss from the specified event that the organization maintains.

5. The method of claim 1, wherein each proposed set of controls of the plurality of proposed sets of controls includes one or more of: a technical component or tool, an architectural aspect, an administrative process or policy, or an employee training.

6. The method of claim 1, wherein the plurality of proposed sets of controls includes the baseline set of controls.

7. The method of claim 6, wherein the baseline set of controls represents a set of controls currently implemented by the organization.

8. The method of claim 1, wherein the plurality of proposed sets of controls is selected from a list of predefined proposed sets of controls.

9. The method of claim 1, wherein the return on investment for each proposed set of controls of the plurality of proposed sets of controls is calculated, over a defined period, as a reduction in loss basis relative to a status quo loss basis that is expected over the defined period if the each proposed set of controls is implemented minus a financial cost to implement the each proposed set of controls, divided by the financial cost to implement the each proposed set of controls.

10. The method of claim 1, wherein the delivering comprises summarizing a plurality of returns on investment for the subset via a graphical user interface presented on the remote user endpoint device.

11. The method of claim 10, wherein the graphical user interface presents the plurality of returns on investment as mean returns on investment.

12. The method of claim 11, wherein the mean returns on investment comprise five-year annualized average returns on investment.

13. The method of claim 11, wherein the graphical user interface further presents, for each proposed set of controls in the subset, a cost of capital to cover at least one percentile loss.

14. The method of claim 1, wherein the modifying comprises sending an instruction that causes a machine to change a setting of a technical component or tool of an information technology infrastructure of the organization.

15. The method of claim 1, wherein the modifying comprises sending an instruction that causes a machine to change an architectural aspect of an information technology infrastructure of the organization.

16. The method of claim 1, wherein the modifying comprises sending an instruction that causes a machine to update or revise an administrative process or a policy of the organization.

17. The method of claim 1, wherein the modifying comprises sending an instruction that causes a machine to update or revise an employee training material of the organization.

18. The method of claim 1, wherein the return on investment is calculated as a cost-of-capital-based return on investment.

19. A non-transitory computer readable storage medium storing instructions which, when executed by a processing system including at least one processor, cause the processing system to perform operations comprising:
calculating, for each proposed set of controls in a plurality of proposed sets of controls for protecting against a specified loss event, a loss basis incurred by an organization due to the specified loss event, assuming the each set of controls is implemented;
calculating, for the each proposed set of controls and using the loss basis as a proxy for an effective annualized cost of capital to cover the specified loss event, a return on investment in the each proposed set of controls;
delivering to a remote user endpoint device, data summarizing the return on investment for at least a subset of the plurality of proposed sets of controls;
receiving a signal from the remote user endpoint device indicating a selection of a selected set of controls from the subset; and
modifying a baseline set of controls to implement the selected set of controls.

20. A device, comprising:
a processing system including at least one processor; and
a non-transitory computer readable storage medium storing instructions which, when executed by the processing system, cause the processing system to perform operations comprising:
calculating, for each proposed set of controls in a plurality of proposed sets of controls for protecting against a specified loss event, a loss basis incurred by an organization due to the specified loss event, assuming the each set of controls is implemented;
calculating, for the each proposed set of controls and using the loss basis as a proxy for an effective annualized cost of capital to cover the specified loss event, a return on investment in the each proposed set of controls;
delivering to a remote user endpoint device, data summarizing the return on investment for at least a subset of the plurality of proposed sets of controls;
receiving a signal from the remote user endpoint device indicating a selection of a selected set of controls from the subset; and
modifying a baseline set of controls to implement the selected set of controls.
